(19) United States
(12) Patent Application Publication
(10) Pub. No.: US 2008/0279148 A1
(43) Pub. Date: Nov. 13, 2008

(54) TDS-OFDMA COMMUNICATION SYSTEM USER IDENTIFICATION

(75) Inventors: Lin YANG, Fremont, CA (US); Qin LIU, Fremont, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/117,012

(22) Filed: May 8, 2008

Related U.S. Application Data
(60) Provisional application No. 60/916,567, filed on May 8, 2007.

(51) Int. Cl. H04Q 7/00

(52) U.S. Cl. 370/330

(57) ABSTRACT

In a TDS-OFDM communications system for uplink wireless communication multiple accesses through sub-channelization, the system comprising: a plurality of users with each user using a portion of available time-frequency radio resources to achieve orthogonal multiple access; a plurality of available bandwidth, wherein the available bandwidth is divided into multiple sub-bands; at least one the sub-carrier in each sub-band. Inside the sub-band for each user, at least one guard sequence, being used as the guard interval between transmitted symbols.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-035.

U.S. patent application Ser. No. ______ with attorney docket number LSFFT-036.

U.S. patent application Ser. No. ______ with attorney docket number LSFFT-037.

U.S. patent application Ser. No. ______ with attorney docket number LSFFT-038.

U.S. patent application Ser. No. ______ with attorney docket number LSFFT-039.

U.S. patent application Ser. No. ______ with attorney docket number LSFFT-040.

U.S. patent application Ser. No. ______ with attorney docket number LSFFT-041.

U.S. patent application Ser. No. ______ with attorney docket number LSFFT-056.

U.S. patent application Ser. No. ______ with attorney docket number LSFFT-057.

U.S. patent application Ser. No. ______ with attorney docket number LSFFT-058.

### REFERENCE TO RELATED APPLICATIONS

This application claims an invention which was disclosed in Provisional Application No. 60/916,567, filed May 8, 2007 entitled “TDS-OFDMA Communication System User Identification”. The benefit under 35 USC §119(e) of the United States provisional application is hereby claimed, and the aforementioned application is hereby incorporated herein by reference.

### FIELD OF THE INVENTION

The present invention relates generally to an application in a TDS-OFDMA (Time Domain Synchronous—Orthogonal Frequency Division Multiple Access) system, more specifically the present invention relates to TDS-OFDMA Communication system user identification.

### BACKGROUND

TDS-OFDM scheme is known. The scheme can be applied to uplink wireless communication multiple access through sub-channelization. It is desirable to utilize the guard interval between symbols in a TDS-OFDM system in which at least one random or known sequence is used as the guard interval between transmitted symbols. Furthermore, it is desirable to use the random or known sequence for user identification.

### SUMMARY OF THE INVENTION

In TDS-OFDMA systems, at least one random or known sequence is used as the guard interval between transmitted symbols.

In TDS-OFDMA systems, wherein at least one random or known sequence is used as the guard interval between transmitted symbols in which the random or known sequence is further used for user identification.

In a TDS-OFDM communications system for uplink wireless communication multiple accesses through sub-channelization, the system comprising: a plurality of users with each user using a portion of available time-frequency radio resources to achieve orthogonal multiple access; a plurality of available bandwidth, wherein the available bandwidth is divided into multiple sub-bands; at least one the sub-carrier in each sub-band. Inside the sub-band for each user, at least one guard sequence, being used as the guard interval between transmitted symbols.

In a TDS-OFDM communications system for uplink wireless communication multiple accesses through sub-channelization, a method comprising: providing a plurality of users with each user using a portion of available time-frequency radio resources to achieve orthogonal multiple access; providing a plurality of available bandwidth, wherein the available bandwidth is divided into multiple sub-bands; at least one the sub-carrier in each sub-band. Inside the sub-band for each user, at least one guard sequence, being used as the guard interval between transmitted symbols.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a TDS-OFDMA uplink multiple access system in accordance with some embodiments of the invention.

FIG. 1A is an example of a time-frequency allocation of the TDS-OFDMA uplink multiple access system of FIG. 1.

FIG. 1B is an example of a structure of the TDS-OFDMA uplink multiple access system of FIG. 1.

FIG. 2 is an example of a TDS-OFDM uplink initial User ID identification in accordance with some embodiments of the invention.

FIG. 2A is an example of a flowchart depicting the TDS-OFDM uplink initial User ID identification in accordance with some embodiments of the invention.

FIG. 3 is an example of a TDS-OFDM ID identification for handover in accordance with some embodiments of the invention.

FIGS. 3A-3B are an example of a flowchart depicting the TDS-OFDM ID identification for handover in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to at least one random or known sequence is used for user identification. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of at least one random or known sequence being used as the guard interval between transmitted symbols in which at least one random or known sequence is used for user identification described herein. The non-processor circuits may include, but are not limited to, a radio receiver, a radio transmitter, signal drivers, clock circuits, power source circuits, and user input devices. As such, these functions may be interpreted as steps of a method to perform providing at least one random or known sequence is used for user identification within a TDS-OFDMA system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

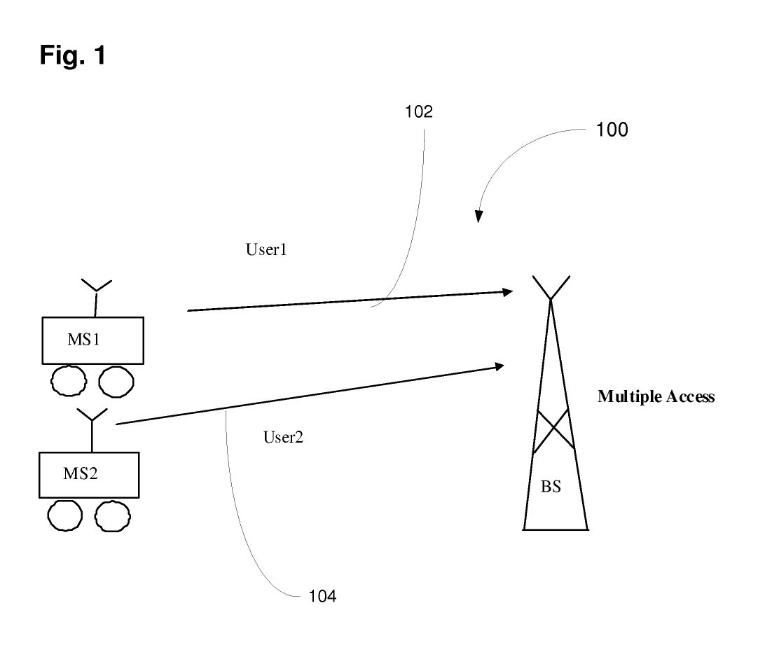

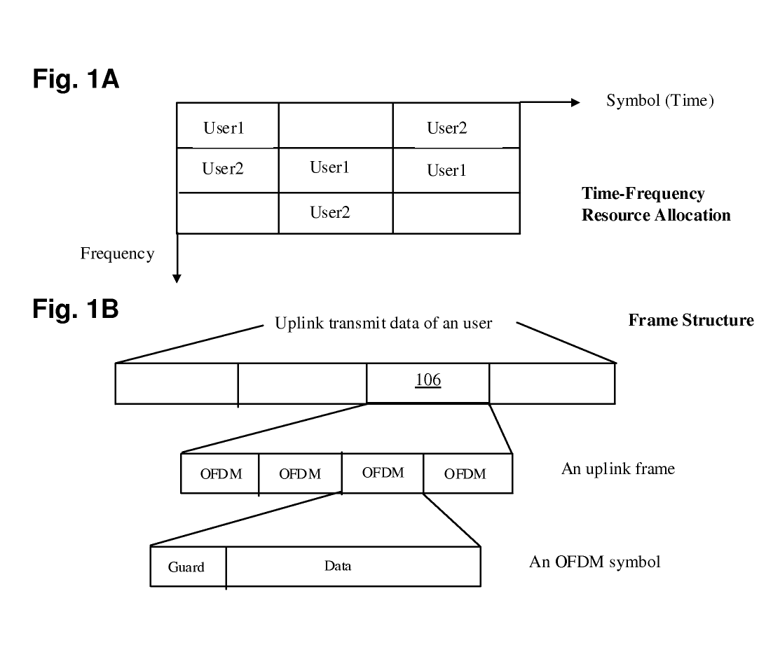

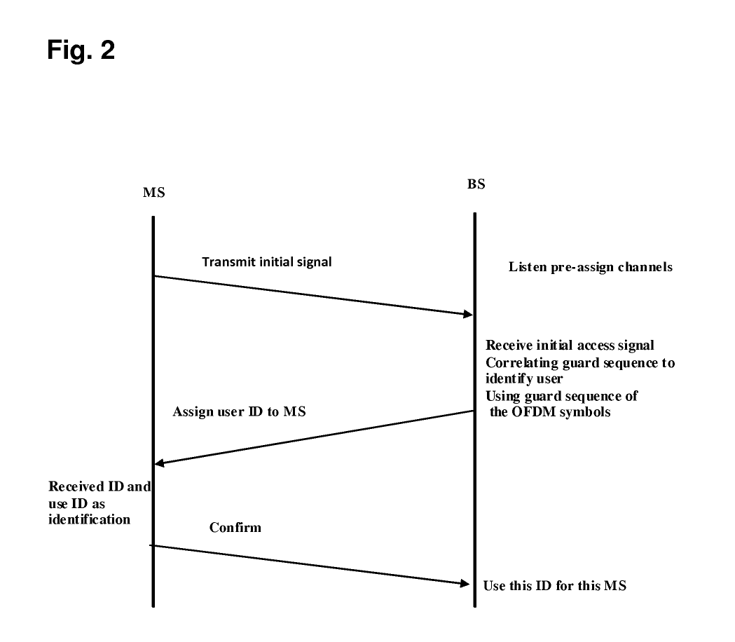

TDS-OFDM can be applied to uplink wireless communication multiple access through sub-channelization, which means each user uses a portion of available time-frequency radio resources to achieve orthogonal multiple access, where the available bandwidth is divided into multiple sub-bands, and the sub-carriers in each sub-band may be continuous or distributed. Inside the bandwidth for each user, at least one guard sequence, which may be random or known, is used as the guard interval between transmitted symbols, see FIGS. 1-1B.

In a TDS-OFDM in uplink transmission, different users use different time-frequency resource allocation respectively. The available bandwidth is divided into multiple sub-bands. The sub-carriers in each sub-band may be continuous or distributed. Inside each sub-band, each user transmits uplink data using a frame structure. Each frame consists of multiple OFDM symbols. Each OFDM symbol consists of a time-domain guard sequence and OFDM data. The guard sequence is used for initial access situation. The guard sequence of each OFDM symbol is used to identify user ID if the guard sequence length of one OFDM symbol is of sufficient length, the guard sequence is used for initial access situation. If the guard sequence length of one OFDM symbol is not long enough, a longer guard sequence can be segmented into several shorter ones and each segment of the guard sequence can be used as the guard interval for each OFDM symbol respectively. For initial access, the BS may or may not assign default channels for initial access. The MS transmits signals at random time. If the BS receives the TDS-OFDM signal from MSs, it identifies user ID by identifying the guard sequence of OFDM symbols to achieve quick acquisition. The identified user ID can be used for further communication purposes. For mobility situations occur after initial access, the BS uses the identified user ID to support handover. The target BS knows the user ID, so it can synchronize with the MS without using specifying channels by just receiving transmitting data

Referring to FIG. 1, a TDS-OFDM scheme 100 is applied to uplink wireless communication multiple accesses through sub-channelization. A plurality of users (only two, i.e. User1 and User2 are shown) associated with a plurality of mobile stations (only two, i.e. MS1 and MS2 are shown) are uplinked with a mobile station (MS) for multiple accesses.

Referring to FIG. 1A, a Time-Frequency resource allocation scheme is shown. Each user or each mobile station (MS) uses a portion of available bandwidth to achieve orthogonal multiple access. The sub-carriers in each sub-band may be contiguous or distributed. Users such as User1 and User2 may use same symbol time slot at frequencies orthogonal to each other. On the other hand, Users such as User1 and User2 may use same frequency at different symbol time.

Referring to FIG. 1B, a Frame Structure of a user or MS is shown. A sequence of uplink frames are transmitted by the user. Uplink frames comprises OFDM (orthogonal frequency division multiplexing) symbols. At least some OFDM symbols consist of a guard interval portion and a data portion. The guard interval may have pseudo noise (PN) sequences located therein. It is noted that the present invention contemplates using the PN sequence as guard intervals disclosed in U.S. Pat. No. 7,072,289 to Yang et al which is hereby incorporated herein by reference. However, other types of guard intervals are contemplated by the present invention as well. Inside the bandwidth for each user, at least one random or known sequence is used as the guard interval between transmitted symbols, where the sequence is limited inside the sub-band.

In wireless communication systems, it is required that the mobile station (MS) builds time synchronization with the base station (BS), this is especially important for TDDM (time division data multiplex). The guard sequence of the OFDM symbols of each user can be used to fulfill the function or the process of time synchronization.

In both TDD (time division data multiplex) and FDD (frequency division data multiplex) systems, it is important for the BS to identify the connecting and connected users. Because the guard sequence is used in the OFDM symbols as the guard interval, different users use different guard sequence to distinguish each other.

For initial access, the BS may or may not assign some portion of the available time-frequency radio resources for initial access purposes, and this assignment is known to all the users. The MS transmits the initial access signal (e.g. a few OFDM symbols or a frame of OFDM symbols) at a random time using this default time-frequency resource. The multiple accesses from different MSs may collide and then each collided MS needs to transmit the initial access signal at another random selected time based on some pre-selected algorithm.

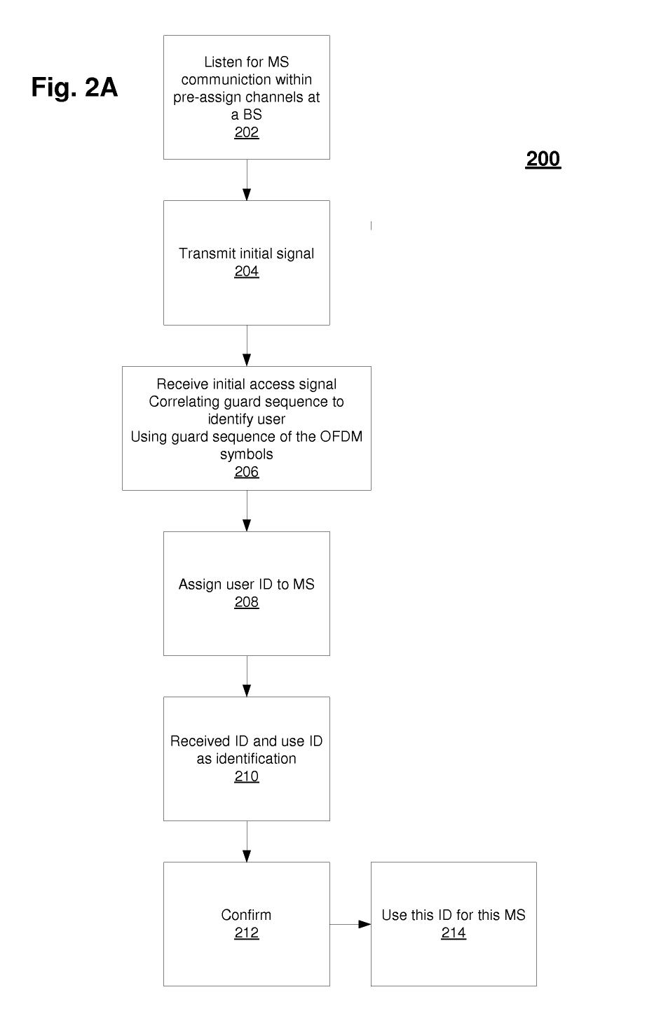

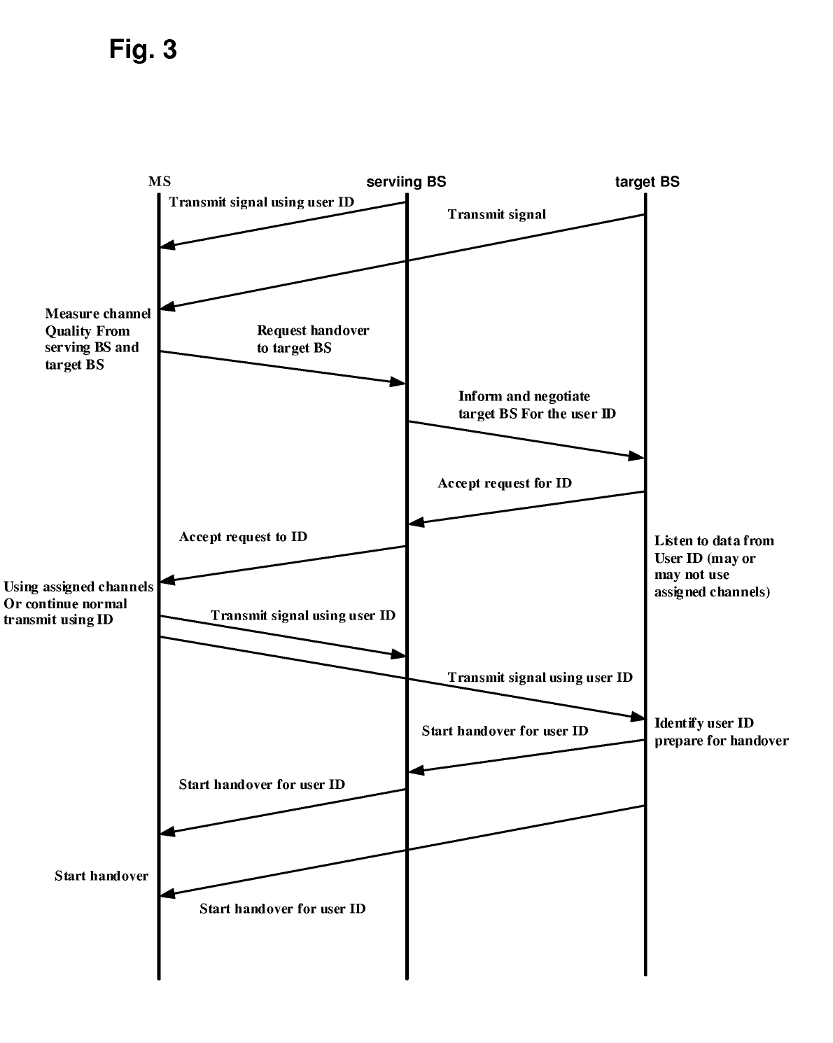

Once the BS receives successfully a transmitted signal from a MS, it can identify the MS based on the acquired guard sequence and assign a user ID to the MS. Then the BS can communicate with the MS using this user ID to remove a time delay related to user ID assignment negotiation, as shown in FIG. 2.

Referring to FIG. 2, an example of a TDS-OFDM uplink initial user identification (ID) is shown. BS Listens in at pre-assigned channels. MS Transmits an initial signal. BS Receives initial access signal and a correlating guard sequence to identify user. The BS Uses the guard sequence of the OFDM symbols for ID purposes. In turn, BS Assigns user ID to MS, which Receives the ID and use the ID as identification or for identification purposes. MS sent a confirming signal to BS. The BS Use this ID for this particular MS.

Referring to FIG. 2A, a first flowchart 200 depicting the present invention is shown. Base station (BS) listens for a mobile station (MS) communication within a set of pre-assigned channels (Step 202). MS Transmits an initial signal to BS (Step 204). BS receives the initial access signal, calculates at least one the guard sequence of the OFDM symbols to identify a user or a MS (Step 206). BS assigns user ID to MS (Step 208). MS Received ID and use ID as identification for same (Step 210). The ID of the MS is confirmed (Step 212). The ID for the MS is starts (Step 214).

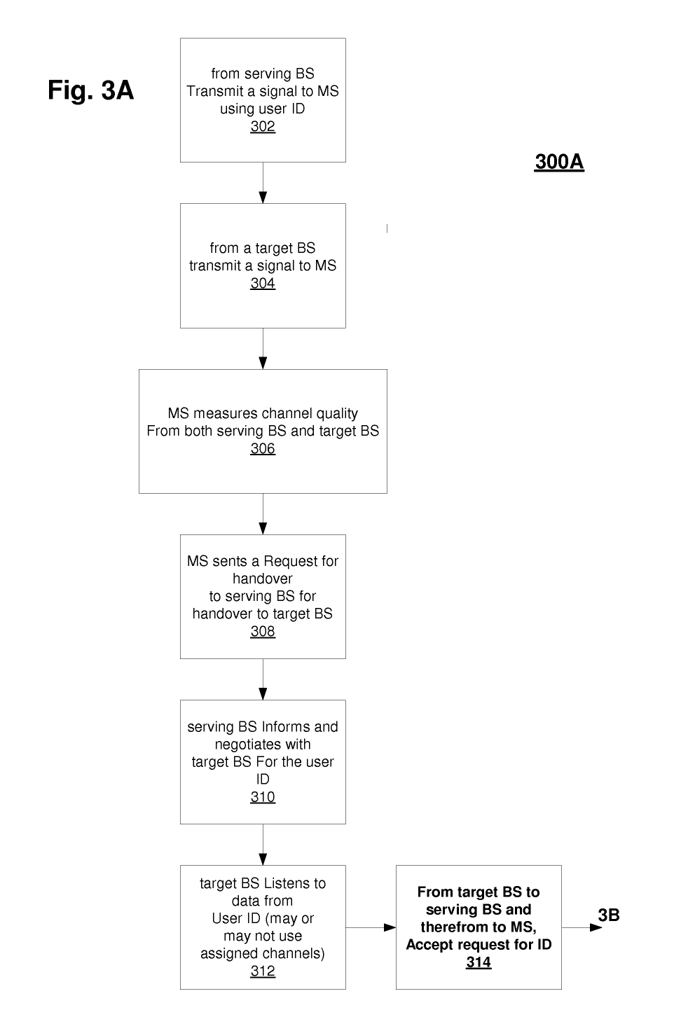

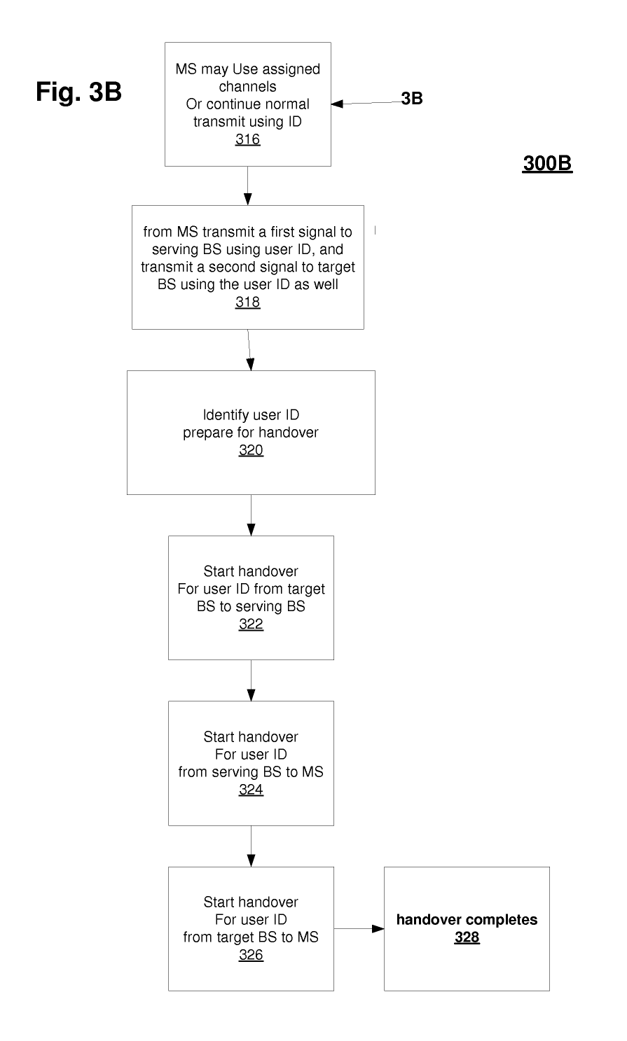

MS may move from one area to another. During the mobility, the MS may travel across several BS and handover is needed. The MS continues to measure communication quality of a serving BS and a target BS. Once the MS decides to make a handover, it will inform serving BS regarding requesting handover. The serving BS will communicate with the target BS to inform and negotiate the handover. If the target BS accepts handover, it will expect receiving signals from the MS based the known user ID received from the serving BS. The MS will send the signals to the target BS based on assigned channels. Alternatively, the target BS receives the MS signals directly if the MS ID is known, to thereby achieve fast handover, as shown in FIG. 3.

Referring to FIGS. 3A-3B, a second flowchart 300A and 300B depicting the TDS-OFDM ID identification for handover are shown. Transmit a signal from a MS to a serving BS using a user ID (Step 302). From a target BS, transmit a signal to MS (Step 304). In turn, MS measures channel quality from both serving BS and target BS (Step 306). MS sents a request for handover to serving BS for handover to target BS (Step 308). Serving BS Informs and negotiates with target BS for the user ID (Step 310). Target BS Listens to data pertaining to this User ID (Step 312). Note that target BS may or may not use assigned channels for the listening. From target BS to serving BS and therefrom to MS, accept the request for ID (Step 314).

Referring to FIG. 3B, the second part of the flowchart 300B is shown. MS may Use assigned channels Or continue normal transmit using ID (Step 316). from MS transmit a first signal to serving BS using user ID, and transmit a second signal to target BS using the user ID as well (Step 318). Identify user ID prepare for handover (Step 320). Start handover for user ID from target BS to serving BS (Step 322). Thereafter, Start handover for user ID from serving BS to MS (Step 324). Thereafter, start handover for user ID from target BS to MS (Step 326). Handover completes (Step 328).

It is advantageous over other systems in the use of guard sequence of the received signal of each user to calculate the frequency offset between symbols or data in such systems as TDS-OFDMA systems. The advantages include improved channel estimation time, improved synchronization time, and less need to insert more known values such as pilots in what would be used or reserved for data.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In a TDS-OFDM communications system for uplink wireless communication multiple accesses through sub-channelization, the system comprising:
a plurality of users with each user using a portion of available time-frequency radio resources to achieve orthogonal multiple access;
a plurality of available bandwidth, wherein the available bandwidth is divided into multiple sub-bands;
at least one the sub-carrier in each sub-band;
at least one guard sequence, being used as the guard interval between transmitted symbols.

2. The system of claim 1, wherein the sub-band is continuous.

3. The system of claim 1, wherein the sub-band is distributed.

4. The system of claim 1, wherein the guard sequence is a random sequence.

5. The system of claim 1, wherein the guard sequence is a known sequence.

6. The system of claim 1, wherein a first user uses a first guard sequence, and a second user uses a second guard sequence, wherein the first guard sequence is different from the second guard sequence.

7. The system of claim 1, wherein at least one guard sequence is associated with a unique user ID.

8. In a TDS-OFDM communications system for uplink wireless communication multiple accesses through sub-channelization, a method comprising the steps of:
providing a plurality of users with each user using a portion of available time-frequency radio resources to achieve orthogonal multiple access;
providing a plurality of available bandwidth, wherein the available bandwidth is divided into multiple sub-bands;
providing at least one the sub-carrier in each sub-band;
providing at least one guard sequence, being used as the guard interval between transmitted symbols.

9. The method of claim 8, wherein the sub-band is continuous.

10. The method of claim 8, wherein the sub-band is distributed.

11. The method of claim 8, wherein the guard sequence is a random sequence.

12. The method of claim 8, wherein the guard sequence is a known sequence.

13. The method of claim 8, wherein a first user uses a first guard sequence, and a second user uses a second guard sequence, wherein the first guard sequence is different from the second guard sequence.

14. The method of claim 8, wherein at least one guard sequence is associated with a unique user ID.
